(19) United States
(12) Patent Application Publication
(10) Pub. No.: US 2024/0347968 A1
(43) Pub. Date: Oct. 17, 2024

(54) Connector Housing, Mating Connector Housing Assembly and Connector Assembly

(71) Applicants: Tyco Electronics (Suzhou) Ltd., Suzhou City (CN); Tyco Electronics (Shanghai) Co., Ltd., Shanghai (CN)

(72) Inventors: Zhihui (Vito) Tang, Suzhou (CN); Feng (Charles) Wan, Shanghai (CN); Zhaowen Zhou, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 18/632,443

(22) Filed: Apr. 11, 2024

(30) Foreign Application Priority Data
Apr. 11, 2023 (CN) 202320787347.X

(51) Int. Cl. H01R 13/629; H01R 13/52

(52) U.S. Cl. CPC H01R 13/62944; H01R 13/5202; H01R 13/5219

(57) ABSTRACT

A connector housing includes a peripheral wall and a rack part formed on an outer surface of the peripheral wall. The rack part has an inner side and an outer side opposite the inner side in a width direction. The inner side of the rack part is connected to the peripheral wall. The rack part has a first tooth slot and a second tooth slot adjacent to the first tooth slot in a length direction. The first tooth slot meshes with a first tooth on a gear part of a mating connector and the second tooth slot meshes with a second tooth on the gear part. A slot width of the second tooth slot is smaller than the first tooth slot and prevents the first tooth with a tooth width larger than the slot width of the second tooth slot from engaging in the second tooth slot.

### CROSS-REFERENCE TO RELATED APPLICATION

This application claims the benefit of the filing date under 35 U.S.C. § 119 (a)-(d) of Chinese Patent Application No. 202320787347.X, filed on Apr. 11, 2023.

### FIELD OF THE INVENTION

The present invention relates to a connector housing, a mating connector housing assembly, and a connector assembly comprising the connector housing and the mating connector housing assembly.

### BACKGROUND

In order to lock a connector housing and a mating connector housing in a mating state, a rack part is usually formed on the outer surface of the connector housing, and adjacent first and second tooth slots are formed on the rack part. A locking rod is rotatably installed on the mating connector housing; a gear part formed on the locking rod. A first tooth and a second tooth are formed on the gear part for respectively meshing with the first tooth slot and the second tooth slot.

The first and second tooth slots are exactly the same, which leads to the second tooth being mistakenly engaged into the first tooth slot when the locking rod is not correctly reset to the pre-lock position, increasing the risk of mis-operation.

### SUMMARY

A connector housing includes a peripheral wall and a rack part formed on an outer surface of the peripheral wall. The rack part has an inner side and an outer side opposite the inner side in a width direction. The inner side of the rack part is connected to the peripheral wall. The rack part has a first tooth slot and a second tooth slot adjacent to the first tooth slot in a length direction. The first tooth slot meshes with a first tooth on a gear part of a mating connector and the second tooth slot meshes with a second tooth on the gear part. A slot width of the second tooth slot is smaller than the first tooth slot and prevents the first tooth with a tooth width larger than the slot width of the second tooth slot from engaging in the second tooth slot.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector assembly according to an exemplary embodiment of the present invention;

FIG. 2 shows an illustrative exploded view of a connector assembly according to an exemplary embodiment of the present invention;

FIG. 3 shows an illustrative perspective view of a connector housing according to an exemplary embodiment of the present invention;

FIG. 4 shows an illustrative perspective view of a mating connector housing assembly according to an exemplary embodiment of the present invention;

FIG. 5 shows an illustrative perspective view of a mating connector housing according to an exemplary embodiment of the present invention;

FIG. 6 shows an illustrative perspective view of a locking rod of a mating connector according to an exemplary embodiment of the present invention when viewed from one side;

FIG. 7 shows an illustrative perspective view of a locking rod of a mating connector according to an exemplary embodiment of the present invention when viewed from the other side;

FIG. 8 shows a cross-sectional view of a connector assembly according to an exemplary embodiment of the present invention, wherein the locking rod is in a pre-lock position; and

FIG. 9 shows a cross-sectional view of a connector assembly according to another exemplary embodiment of the present invention, wherein the locking rod is in a pre-lock position.

### DETAILED DESCRIPTION OF EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

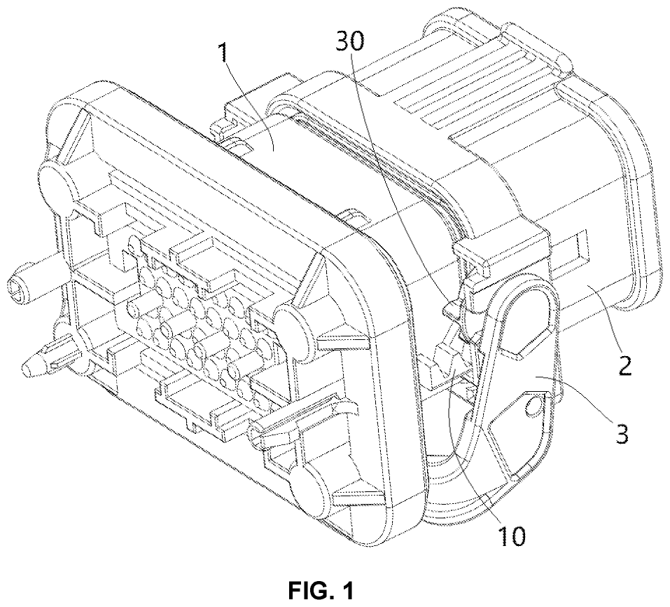

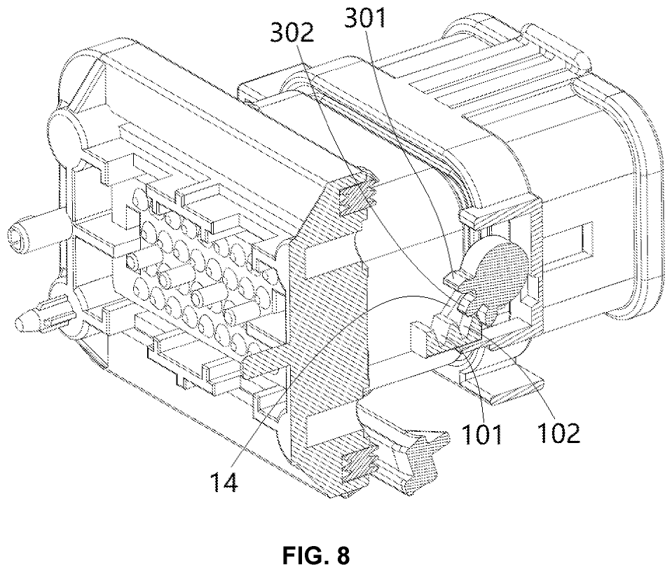

As shown in FIGS. 1 to 3, in an exemplary embodiment of the present invention, a connector housing 1 is disclosed. The connector housing 1 includes a peripheral wall 11 and a rack part 10. The rack part 10 is formed on the outer surface of the peripheral wall 11. The rack part 10 has opposite inner and outer sides in its width direction X, and the inner side of the rack part 10 is connected to the peripheral wall 11. The rack part 10 has a first tooth slot 101 and a second tooth slot 102 adjacent to each other in a length direction Y of the rack part 10. As shown in FIG. 8, the first tooth slot 101 and the second tooth slot 102 on the rack part 10 are used to mesh with a first tooth 301 and a second tooth 302 on a gear part 30 of the mating connector, respectively.

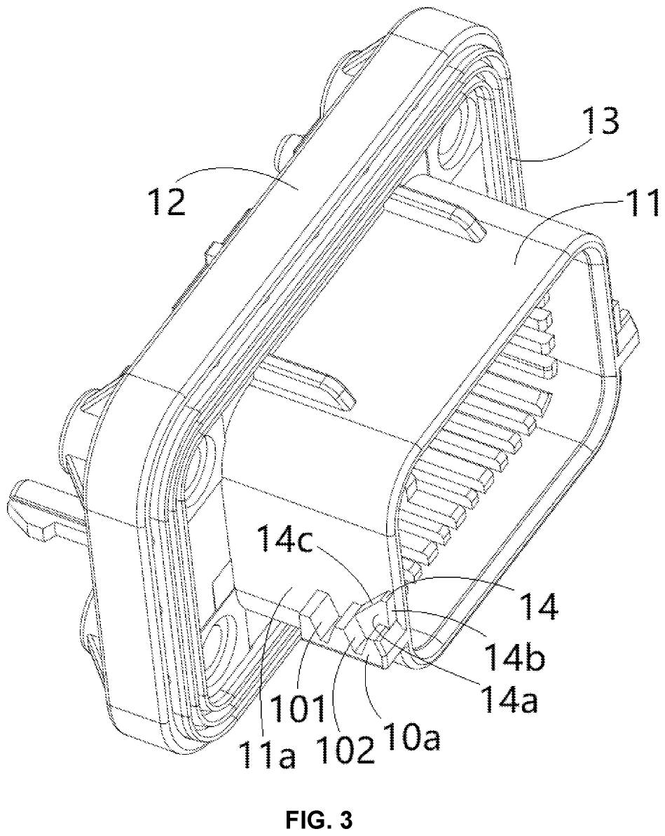

In the illustrated embodiments, the slot width of the second tooth slot 102 in the width direction X is smaller than that of the first tooth slot 101, in order to prevent the first tooth 301 with a tooth width larger than the slot width of the second tooth slot 102 from being wrongly engaged in the second tooth slot 102. As shown in FIG. 3, a blocking part 14 is formed on the outer surface of the peripheral wall 11 of the connector housing 1. At least a portion of the blocking part 14 is located in the second tooth slot 102, so that the slot width of the second tooth slot 102 is smaller than that of the first tooth slot 101. As shown in FIG. 3, the first tooth slot 101 extends from the outer side surface 10a of the rack part 10 to the outer surface of the peripheral wall 11 in the width direction X, so that the slot width of the first tooth slot 101 is equal to the width of the rack part 10.

The blocking part 14 has opposite inner and outer sides in the width direction X, and the inner side of the blocking part 14 is connected to the peripheral wall 11, as shown in FIG. 3. The second tooth slot 102 extends from the outer side surface 10a of the rack part 10 to the outer side surface 14a of the blocking part 14 in the width direction X, so that the slot width of the second tooth slot 102 is smaller than the width of the rack part 10.

The peripheral wall 11 of the connector housing 1, as shown in FIG. 3, has two opposite side walls 11a in the width direction X. The rack part 10 protrudes from the side wall 11a of the peripheral wall 11, and the outer surface of the side wall 11a, the outer side surface 10a of the rack part 10, and the outer side surface 14a of the blocking part 14 are parallel to each other. The blocking part 14 extends along the height direction Z of the rack part 10 beyond the opening of the second tooth slot 102 to block the first tooth 301 outside the opening of the second tooth slot 102. In the illustrated embodiments, the height of the blocking part 14 extending upwards from the opening of the second tooth slot 102 is not less than the tooth height of the first tooth 301 and the second tooth 302.

As shown in the embodiment of FIG. 3, the blocking part 14 has a front side surface 14b and a rear side surface 14c opposite to each other in the length direction Y, and the rear side surface 14c of the blocking part 14 is adjacent to the first tooth slot 101. The front side surface 14b of the blocking part 14 extends vertically along the height direction Z to block the first tooth 301 from crossing over the blocking part 14 backwards. The rear side surface 14c of the blocking part 14 is inclined relative to the height direction Z to allow the first tooth 301 to cross over the blocking part 14 forward.

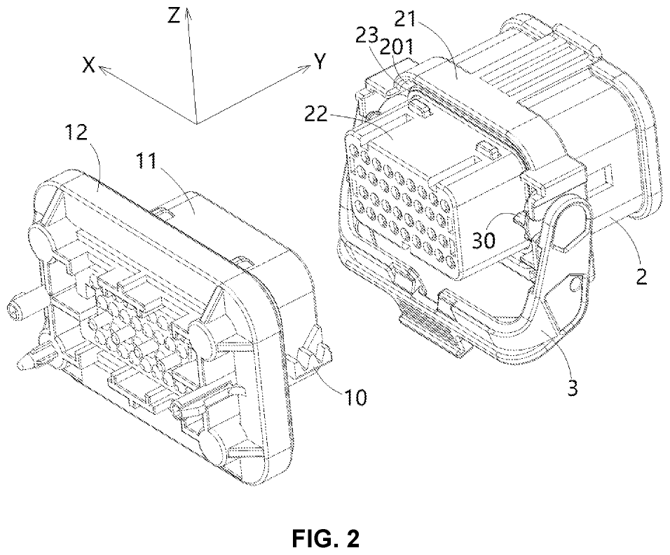

In another exemplary embodiment of the present invention, a mating connector housing assembly is also disclosed. The mating connector housing assembly includes, as shown in FIGS. 1 and 2, a mating connector housing 2 and a locking rod 3. The mating connector housing 2 is suitable for mating with the aforementioned connector housing 1. The locking rod 3 is rotatably installed on the mating connector housing 2 and can be rotated between a pre lock position and a final lock position.

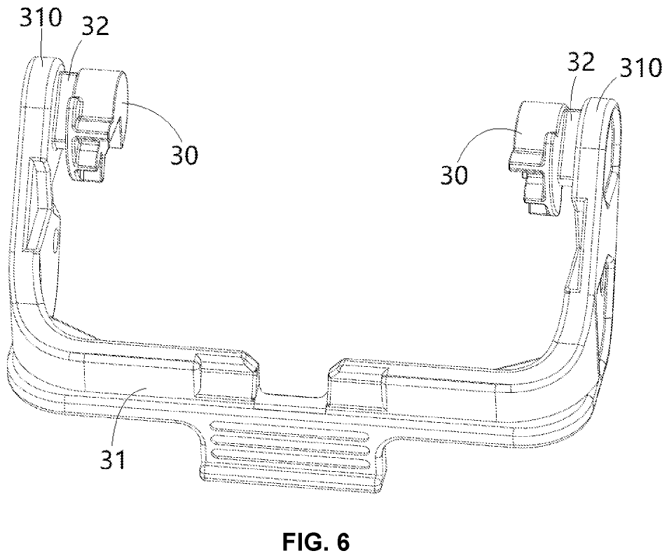

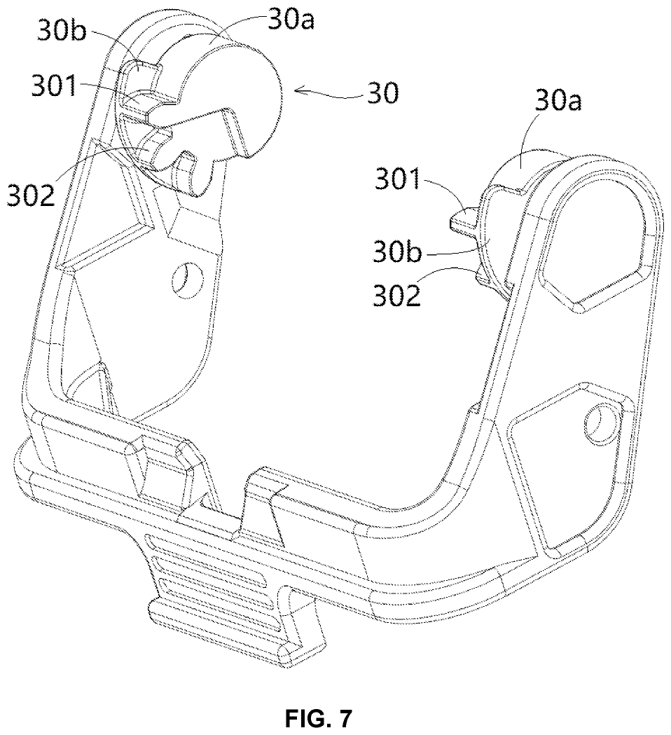

As shown in FIG. 6, in the illustrated embodiment, a gear part 30 is formed on the locking rod 3. The gear part 30, as shown in FIG. 7, has a first teeth 301 and a second teeth 302 adjacent to each other in the circumferential direction of the gear part 30, and the tooth widths of the first teeth 301 and second teeth 302 are equal to the slot widths of the first tooth slot 101 and the second tooth slot 102 on the rack part 10, respectively.

When the locking rod 3 is in the pre lock position (as shown in FIG. 8), the first tooth 301 and the second tooth 302 are in positions corresponding to the first tooth slot 101 and the second tooth slot 102, respectively, to allow the first tooth 301 and the second tooth 302 to mesh with the first tooth slot 101 and the second tooth slot 102, respectively. When the locking rod 3 is not in the pre lock position and is rotated toward the rack part 10, the first tooth 301 and the second tooth 302 cannot mesh with the first tooth slot 101 and the second tooth slot 102, respectively. This can prevent accidental mis-operation.

When the locking rod 3 is rotated from the pre lock position to the final lock position, the first tooth 301 and the second tooth 302 respectively engage with the first tooth slot 101 and the second tooth slot 102 to lock the connector housing 1 and the mating connector housing 2 in the mating state.

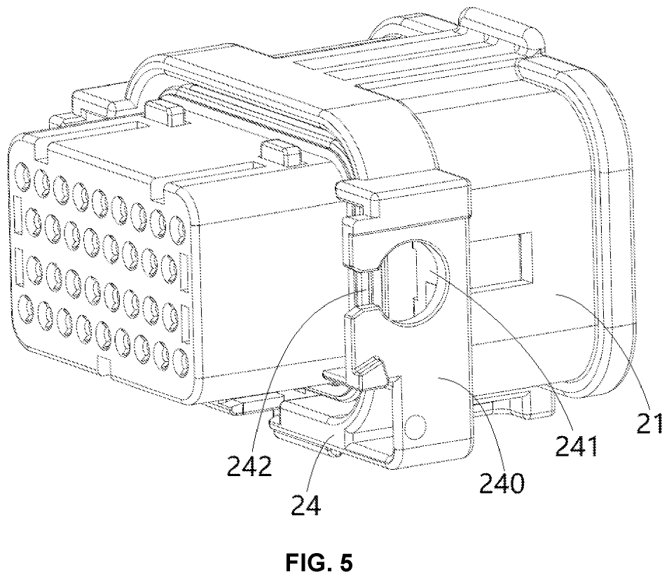

The locking rod 3, as shown in FIG. 6, includes a lever portion 31, the gear part 30, and a shaft part 32. The lever portion 31 has a connecting end 310. The gear part 30 is connected to the connecting end 310. The shaft part 32 is axially connected between the connecting end 310 and the gear part 30. A pivot hole 241, shown in FIG. 5, is formed in the mating connector housing 2, and the shaft part 32 of the locking rod 3 is rotatably installed in the pivot hole 241.

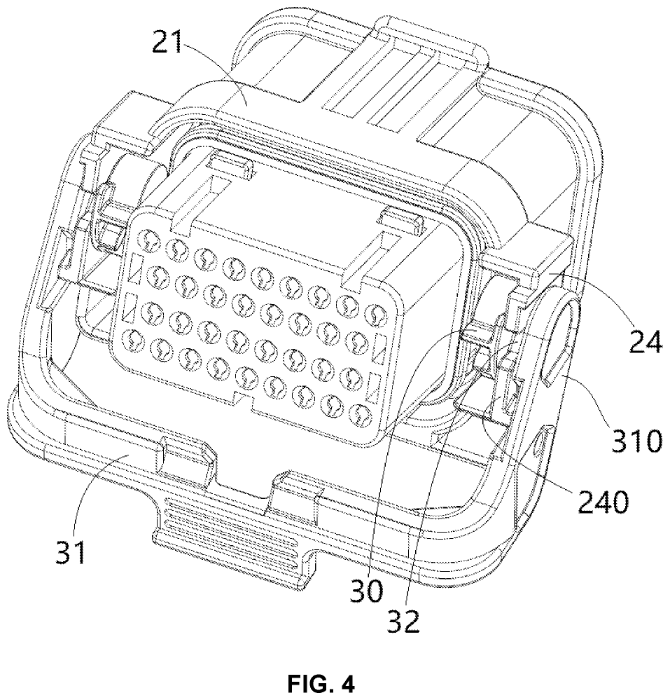

As shown in FIGS. 4 and 5, in the illustrated embodiments, an installation portion 24 is formed on the outer peripheral wall 21 of the mating connector housing 2, which includes a support plate 240, and the pivot hole 241 is formed in the support plate 240. A mounting notch 242 is formed on the support plate 240 that is communicated with the pivot hole 241, and the shaft part 32 is installed into the pivot hole 241 through the mounting notch 242. The outer side surface of the support plate 240 is against the connecting end 310 of the lever portion 31, and the inner side surface of the support plate 240 is against the end face of the gear part 30 to prevent axial movement of the gear part 30 relative to the support plate 240.

As shown in FIG. 7, the gear part 30 includes a wheel shaft part 30a. The wheel shaft part 30a is connected to the connecting end 310 of the lever portion 31, shown in FIG. 6. The first tooth 301 and the second tooth 302 are formed on the outer peripheral surface of the wheel shaft part 30a.

As shown in FIG. 7, the first tooth 301 and the second tooth 302 have opposite sides in the axial direction of the wheel shaft part 30a, respectively. The gear part 30 also includes a web plate 30b that extends radially from the wheel shaft part 30a, which is connected to one sides of the first tooth 301 and the second tooth 302. The distance from the other side of the first tooth 301 to the web plate 30b is greater than the distance from the other side of the second tooth 302 to the web plate 30b, so that the tooth width of the first tooth 301 is greater than that of the second tooth 302.

In another exemplary embodiment of the present invention, a connector assembly is disclosed. The connector assembly, as shown in FIG. 1, includes a connector and a mating connector suitable for mating with the connector. The connector includes: a connector housing 1 and a terminal provided in the connector housing 1. The mating connector includes: a mating connector housing assembly and a mating terminal. The mating terminal is provided in the mating connector housing 2 and mated with the terminal.

As shown in FIG. 2, in the illustrated embodiments, a radially protruding flange portion 12 is formed on the peripheral wall 11 of the connector housing 1, which is used to be fixed to a mounting panel to install the connector housing 1 onto the mounting panel. The connector also includes a first sealing ring 13 arranged on the flange portion 12, as shown in FIG. 3, which is suitable for being axially compressed between the flange portion 12 and the mounting panel to achieve sealing between the two.

As shown in FIG. 2, the mating connector housing 2 comprises an outer peripheral wall 21 and a terminal holder 22. The terminal holder 22 is connected to the outer peripheral wall 21 and extends out of one end of the outer peripheral wall 21. The terminal holder 22 is used to hold the mating terminal and is adapted to be inserted into the connector housing 1. An annular groove 201 is formed between the outer peripheral wall 21 and the terminal holder 22 of the mating connector housing 2. The mating connector also includes a second scaling ring 23, which is provided in the annular groove 201 and axially compressed between the connector housing 1 and the mating connector housing 2 to achieve sealing between the two.

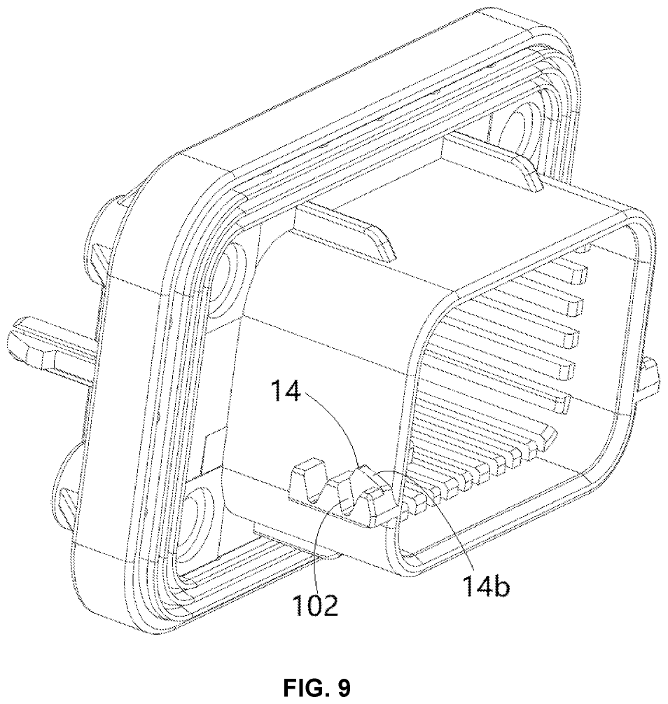

FIG. 9 shows a cross-sectional view of a connector assembly according to another exemplary embodiment of the present invention, wherein the locking rod 3 is in the pre lock position. The difference between the connector assembly shown in FIG. 9 and the connector assembly shown in FIGS. 1-8 is the structure of the blocking part 14 on the connector housing 1.

As shown in FIG. 9, in the illustrated embodiment, the height of the blocking part 14 extending upwards from the opening of the second tooth slot 102 is smaller than the tooth height of the first tooth 301 and the second tooth 302. The blocking part 14 has a front side surface 14b and a rear side surface 14c opposite to each other in the length direction Y, and the rear side surface 14c of the blocking part 14 is adjacent to the first tooth slot 101. The front side surface 14b of the blocking part 14 is inclined relative to the height direction Z to allow the first tooth 301 to cross over the blocking part 14 backwards. The rear side surface 14c of the blocking part 14 is inclined relative to the height direction Z to allow the first tooth 301 to cross over the blocking part 14 forward.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector housing, comprising:
a peripheral wall; and
a rack part formed on an outer surface of the peripheral wall, the rack part has an inner side and an outer side opposite the inner side in a width direction, the inner side of the rack part is connected to the peripheral wall, the rack part has a first tooth slot and a second tooth slot adjacent to the first tooth slot in a length direction, the first tooth slot meshes with a first tooth on a gear part of a mating connector and the second tooth slot meshes with a second tooth on the gear part, a slot width of the second tooth slot in the width direction is smaller than a slot width of the first tooth slot and prevents the first tooth with a tooth width larger than the slot width of the second tooth slot from engaging in the second tooth slot.

2. The connector housing of claim 1, wherein the peripheral wall has a blocking part on the outer surface, a portion of the blocking part is in the second tooth slot and makes the slot width of the second tooth slot smaller than the slot width of the first tooth slot.

3. The connector housing of claim 2, wherein the first tooth slot extends from the outer side of the rack part to the outer surface of the peripheral wall in the width direction, the slot width of the first tooth slot is equal to a width of the rack part.

4. The connector housing of claim 2, wherein the blocking part has an inner side and an outer side opposite the inner side in the width direction, the inner side of the blocking part is connected to the peripheral wall, the second tooth slot extends from the outer side of the rack part to the outer side of the blocking part in the width direction, the slot width of the second tooth slot is smaller than the width of the rack part.

5. The connector housing of claim 4, wherein the peripheral wall has a pair of side walls opposite one another in the width direction, the rack part protrudes from one of the side walls of the peripheral wall, the outer surface of the one of the side walls, the outer surface of the rack part, and the outer side of the blocking part are parallel to each other.

6. The connector housing of claim 4, wherein the blocking part extends along a height direction of the rack part beyond an opening of the second tooth slot to block the first tooth from an outside of the opening of the second tooth slot.

7. The connector housing of claim 6, wherein a height of the blocking part extending upwards from the opening of the second tooth slot is not less than a tooth height of the first tooth and the second tooth.

8. The connector housing of claim 7, wherein the blocking part has a front side surface and a rear side surface opposite to each other in the length direction, the rear side surface is adjacent to the first tooth slot, the front side surface of the blocking part extends vertically along the height direction and blocks the first tooth from crossing over the blocking part in one direction, the rear side surface of the blocking part is inclined relative to the height direction to allow the first tooth to cross over the blocking part in a direction opposite to the one direction.

9. The connector housing of claim 6, wherein a height of the blocking part extending upwards from the opening of the second tooth slot is smaller than the tooth height of the first tooth and the second tooth.

10. The connector housing of claim 9, wherein the blocking part has a front side surface and a rear side surface opposite to each other in the length direction, the rear side surface is adjacent to the first tooth slot, the front side surface of the blocking part is inclined relative to the height direction to allow the first tooth to cross over the blocking part in one direction, the rear side surface of the blocking part is inclined relative to the height direction to allow the first tooth to cross over the blocking part in a direction opposite to the one direction.

11. A mating connector housing assembly, comprising:
a mating connector housing matable with a connector housing; and
a locking rod rotatably installed on the mating connector housing and rotatable between a pre-lock position and a final lock position, the locking rod has a gear part, the gear part has a first tooth and a second tooth adjacent to the first tooth in a circumferential direction, a tooth width of the first tooth is equal to a slot width of a first tooth slot on a rack part of the connector housing and a tooth width of the second tooth is equal to a slot width of a second tooth slot on the rack part, the first tooth and the second tooth are in positions corresponding to the first tooth slot and the second tooth slot when the locking rod is in the pre-lock position to allow the first tooth to mesh with the first tooth slot and the second tooth to mesh with the second tooth slot, the first tooth engages with the first tooth slot and the second tooth engages with the second tooth slot when the locking rod is rotated from the pre-lock position to the final lock position to lock the connector housing and the mating connector housing in a mating state.

12. The mating connector housing assembly of claim 11, wherein the locking rod includes a lever portion having a connecting end, the gear part connected to the connecting end, and a shaft part axially connected between the connecting end and the gear part, a pivot hole is formed in the mating connector housing, the shaft part is rotatably installed in the pivot hole.

13. The mating connector housing assembly of claim 12, wherein an installation portion is formed on an outer peripheral wall of the mating connector housing, the installation portion has a support plate, the pivot hole is formed in the support plate, a mounting notch is formed on the support plate in communication with the pivot hole, the shaft part is installed into the pivot hole through the mounting notch.

14. The mating connector housing assembly of claim 13, wherein an outer side surface of the support plate is against the connecting end of the lever portion and an inner side surface of the support plate is against an end face of the gear part to prevent axial movement of the gear part relative to the support plate.

15. The mating connector housing assembly of claim 12, wherein the gear part has a wheel axle part connected to the connecting end of the lever portion, the first tooth and the second tooth are formed on an outer peripheral surface of the wheel axle part.

16. The mating connector housing assembly of claim 15, wherein the first tooth and the second tooth each have opposite sides in an axial direction of the wheel axle part, the gear part has a web plate radially extending from the wheel axle part, the web plate is connected to one of the sides of the first tooth and the second tooth, a distance from another side of the first tooth to the web plate is greater than a distance from another side of the second tooth to the web plate, the tooth width of the first tooth is greater than the tooth width of the second tooth.

17. A connector assembly, comprising:
a connector comprising a connector housing and a terminal disposed in the connector housing, the connector housing including a peripheral wall and a rack part formed on an outer surface of the peripheral wall, the rack part has an inner side and an outer side opposite the inner side in a width direction, the inner side of the rack part is connected to the peripheral wall, the rack part has a first tooth slot and a second tooth slot adjacent to the first tooth slot in a length direction; and
a mating connector comprising a mating connector housing assembly and a mating terminal disposed in the mating connector housing assembly and mated with the terminal, the mating connector housing assembly including a mating connector housing matable with the connector housing and a locking rod rotatably installed on the mating connector housing and rotatable between a pre-lock position and a final lock position, the locking rod has a gear part, the gear part has a first tooth and a second tooth adjacent to the first tooth in a circumferential direction, a tooth width of the first tooth is equal to a slot width of the first tooth slot and a tooth width of the second tooth is equal to a slot width of the second tooth slot, the first tooth and the second tooth are in positions corresponding to the first tooth slot and the second tooth slot when the locking rod is in the pre-lock position to allow the first tooth to mesh with the first tooth slot and the second tooth to mesh with the second tooth slot, the first tooth engages with the first tooth slot and the second tooth engages with the second tooth slot when the locking rod is rotated from the pre-lock position to the final lock position to lock the connector housing and the mating connector housing in a mating state, the slot width of the second tooth slot in the width direction is smaller than the slot width of the first tooth slot and prevents the first tooth with the tooth width larger than the slot width of the second tooth slot from engaging in the second tooth slot.

18. The connector assembly of claim 17, wherein a flange portion is formed on the peripheral wall of the connector housing, the flange portion fixes a mounting panel to install the connector housing onto the mounting panel, the connector includes a first sealing ring arranged on the flange portion that is axially compressed between the flange portion and the mounting panel to achieve sealing between the flange portion and the mounting panel.

19. The connector assembly of claim 17, wherein the mating connector housing includes an outer peripheral wall and a terminal holder connected to the outer peripheral wall that extends out of one end of the outer peripheral wall, the terminal holder holds the mating terminal and is insertable into the connector housing.

20. The connector assembly of claim 19, wherein an annular groove is formed between the outer peripheral wall and the terminal holder of the mating connector housing, the mating connector has a second sealing ring provided in the annular groove and axially compressed between the connector housing and the mating connector housing to achieve sealing between the connector housing and the mating connector housing.
